(19) United States
(12) Patent Application Publication
(10) Pub. No.: US 2007/0219850 A1
(43) Pub. Date: Sep. 20, 2007

(54) METHODS AND SYSTEMS FOR DISPLAYING AND TRENDING OPPORTUNITY, CONTACT AND ACTIVITY INFORMATION

(75) Inventors: Dean Fischer, Glen Ellyn, IL (US); Erik Brown, Chicago, IL (US); Cory Chaplin, Chicago, IL (US)

Correspondence Address: JOHN SCOTT WINTERLA, KELLEY DRIVE & WARREN LLP, 400 ALTLANTIC STREET , 13TH FLOOR, STAMFORD, CT, 06901, US

(73) Assignee: West Monroe partners, LLC, Chicago, IL (US)

(21) Appl. No.: 11/669,557

(22) Filed: Jan. 31, 2007

Related U.S. Application Data
(60) Provisional application No. 60/783,437, filed on Mar. 17, 2006.

(51) Int. Cl. G07G 1/00

(52) U.S. Cl. 705/10

(57) ABSTRACT

A configurable web based tool capable of trending analysis and graphically displaying opportunity contact data and activity.

### CROSS-REFERENCE TO RELATED APPLICATIONS

This application claims benefit from U.S. Provisional Patent Application Ser. No. 60/783,4377 filed on Mar. 17, 2006. The disclosure of such application is hereby incorporated by reference in its entirety where appropriate for teachings of additional or alternative details, features, and/or technical background, and from which priority is asserted.

### BACKGROUND OF THE INVENTION

All references cited in this specification, and their references, are incorporated by reference herein where appropriate for teachings of additional or alternative details, features, and/or technical background.

1. Field of the Invention

The present invention generally relates to a computer-based system for displaying business development information, such as, without limitation, data pertaining to opportunity, contact and activity, at a instant in time and/or historically.

2. Description of the Related Art

For as long as people have been maintaining relationships, and more specifically business relationships, people have created, manipulated and used methods to build, maintain, and take advantage of their list of contacts. In relation to business planning and strategies, those in business have sought methods to store and present opportunities for new and continued relations and/or practices directed toward further revenue. The particular method of managing contacts and opportunities can have a direct impact on business success.

The prevalence and continued growth in the use of computers has improved the management of business contacts and opportunities. Similarly, the increasing use of computers and the World Wide Web has facilitated operations within the world economy.

In many cases, contact lists that often started from simple computerized text lists equivalent to paper lists of old have grown into large and complex databases managed by various programs. Conventionally, contact management programs display static information such as, for example, a contact's name, address and company data, merely capturing a point in time. A contact may be an individual or organization within a base system.

Another type of management program holds information pertaining to opportunities or activities. Contacts and opportunities can exist in selling, purchasing, consultancy, and partnering. A contact may or may not be related to an opportunity. Contacts and opportunities may exist on all sides of business relationships. An opportunity may, for example, be a project for a customer who may or may not buy a particular product or service. An activity may, for example, be a level of effort, such as a phone call or meeting performed for an opportunity or a contact.

Current approaches do not allow for data analysis, including historical trending of opportunity and contact data relationships to past data or moments in time. Because current approaches do not provide a repository in which to accrue historical data, known approaches could not trend information. In addition, conventional systems fail to allow display of opportunity and contact data in a graphical or charting representation. Further, conventional approaches do not allow organizations to trend the lifecycle of an opportunity. There is need, therefore, for an improved method and system for displaying contact, opportunity, and activity data.

### SUMMARY OF THE INVENTION

One embodiment discloses a computer-implemented method comprising retrieving data pertaining to an attribute of a business opportunity and depicting the attribute in a graphical or chart representation.

Another embodiment discloses a computer network system having a plurality of servers and a plurality of clients, the system further comprising a means for querying a database comprising information pertaining to one or more opportunities and attributes associated with the opportunities, and a means for analyzing the information to determine the number of opportunities associated with one or more of the attributes that have been realized.

Yet another embodiment discloses a computer-implemented method comprising setting filter parameters with respect to the attributes of an opportunity, obtaining information pertaining to opportunities meeting the set filter parameters, and depicting the filtered information in a graphical or chart representation.

In another embodiment, there is disclosed a computer network system comprising a means for querying a database comprising information pertaining to one or more opportunities and attributes associated with the opportunities, a means for depicting the opportunity attribute(s) in graphical or chart form, and a means for permitting the graphical or chart form into unrelated application software.

### BRIEF DESCRIPTIONS OF DRAWINGS

Embodiments of the invention are illustrated in the accompanying drawings in which:

FIG. 1 is a flow diagram of illustrative steps for rendering opportunities in chart (or graphical) format and for viewing a sortable list of those opportunities and their details;

FIG. 2 is a flow diagram of illustrative steps for viewing a trending analysis related to a specified parameter;

FIG. 3 is a flow diagram of illustrative steps for automatically generating trending data;

FIG. 4 is an exemplary screen shot of a main trend analysis page for the process flow shown in FIG. 1;

FIG. 5 is an exemplary screen shot of an opportunity list for the process flow shown in FIG. 1;

FIG. 6 is an exemplary screen shot of the trending analysis for new contacts that may be produced using the process flows shown in FIG. 2;

FIG. 7 is an exemplary screen shot of the trending analysis for weighted fees for opportunities closing in the next X months that may be produced using the process flows shown in FIG. 2;

FIG. 8 is an exemplary screen shot of a trending analysis with respect to total contacts that may be produced using the process flows shown in FIG. 2;

FIG. 9 is an exemplary screen shot of the trending analysis for new opportunities that may be produced using the process flows shown in FIG. 2;

FIG. 10 is an exemplary screen shot of the trending analysis for stagnant opportunities that may be produced using the process flows shown in FIG. 2;

FIG. 11 is an exemplary screen shot of the trending analysis for opportunities closing in the next 2 months that may be produced using the process flows shown in FIG. 2;

FIG. 12 is an exemplary screen shot of the trending analysis for business development activities that may be produced using the process flows shown in FIG. 2;

FIG. 13 is an illustration showing a representative data processing system suitable for use with the methods and systems consistent with the present invention;

FIG. 14 is a block diagram of an illustrative web server which may find use in the present invention; and

FIG. 15 is a block diagram of an illustrative database server which may find use in the present invention.

### DETAILED DESCRIPTION OF THE INVENTION

Methods, systems, and articles of manufacture consistent with the present invention provide for, but are not limited to, graphically and numerically displaying opportunity, contact and activity data. In one embodiment, a computer-implemented program or application is provided comprising a web-based product that may graphically and numerically display opportunity, contact and activity data. An illustrative program is referred to herein as the “dashboard,” “dashboard manager,” or “business development dashboard.”

In an embodiment, the dashboard may be a configurable web-based tool that graphically and numerically displays opportunities, contacts and activity data. The dashboard may comprise a trending analysis component.

The opportunity dashboard may use point-in-time data from one or more data stores, such as, for example an opportunity data store, or a contact data store. The dashboard may be configured, by software or hardware (or a combination of the same to display a variety of views of the opportunities. Illustrative statistics shown on the dashboard may include, without limitation, a number of opportunities that are open, active, on hold or overdue. It may also display, for example, proposals in a set number of days, weeks, etc., or have overdue proposals. In addition, the number of new, closed and changed opportunities for a period of time, such as current month-to-date, the fiscal year, etc., may be configured for display.

Further to the present embodiment, and in addition to the statistics, the dashboard may present one or more charts. These charts may graphically display a list of opportunities grouped by opportunity attributes. Illustrative attributes may be configured to include, but are not limited to, the length of time an opportunity has been open, the number of opportunities in each sales stage, the number of opportunities in each opportunity type and the number of opportunities from each sales source. Other attributes may include the ratio of opportunities that have been transacted upon month-to-date, year-to-date, and/or since inception. These charts can be further configured in a number of different chart types, such as, for example, bar charts, line charts, pie charts or dials.

In one embodiment, the charts and statistics can be configured by filtering the data to be displayed by the opportunity sales stage, the organizational segment or the estimated close date. The charts and statistics may allow a user to view a list of the opportunities that make up that statistic or chart portion. The list page may also show additional opportunity data that might otherwise not be shown on the dashboard, allowing a view into individual opportunities in lieu of, or in addition to, the aggregations shown on the dashboard.

The trending component, in one possible embodiment of the dashboard, may be configured to display opportunity, contact and activity data over a specified time frame, such as, or example, a day, a week or a month. The data for these trends may be configured to come from one or more data stores, such as, for example an opportunity data store and a contact data store. The illustrative trends that may be configured for display include, but are not limited to, the number of new people contacts, the number of new company contacts, the total number of people contacts, the total number of company contacts, the number of new opportunities, the number of stagnant opportunities, the number of closed opportunities grouped by outcome, the number of opportunities that are estimated to close in the next user specified months, the number of opportunities that are estimated to close in the next user specified months grouped by sales stage, the weighted fees of opportunities that are estimated to close in specified months, and the weighted fees of opportunities that are estimated to close in specified months grouped by opportunity sales stage.

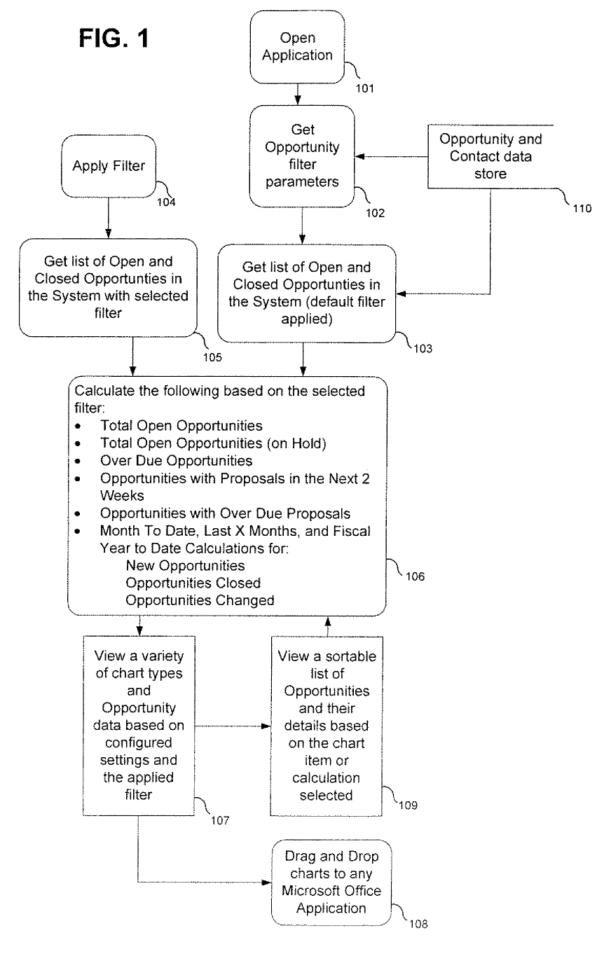

FIG. 1, is a flow diagram depicting one method embodiment of the dashboard component. At step 101, the dashboard is open, and at step 109, a list page is open. Both pages may display a list of opportunities from the one or more data stores, such as, for example, obtaining opportunity data and contact data through an opportunity and contact data database, step 110.

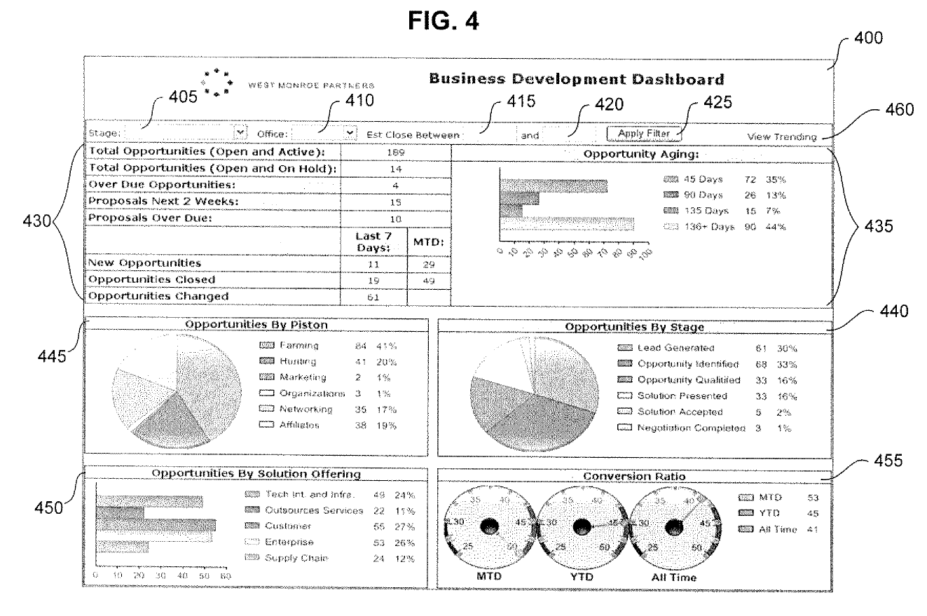

Pages may display a list of opportunities that may be filtered, step 103-105, by selection of user configured criteria. As shown on one embodiment of the dashboard display, as depicted by the screenshot of FIG. 4, the filters can be effectuated by user input to configure what is displayed within the pages, step 107 and/or step 109. The filter may allow the user to specify operators, such as, for example Boolean values “AND”, or “OR”, to designate relationships for narrowing the number of opportunities being displayed. As an exemplar embodiment, a filter may be applied such that a date range reads the opportunity's estimated close date showing opportunities that are/were estimated to close within that date range. Further to the embodiment, an additional filter may be applied, such as, for example, using an “AND” relationship showing opportunities that are allowed by both filters.

Given filtered lists of open and closed opportunities, lists may be configured and calculated, step 106, to show on the dashboard display. Illustrative statistics calculated for the dashboard may comprise: a list of the open and active opportunities in a data store; a list of the open, but on hold, opportunities in a data store; a list of the open, but passed-estimated-close-date opportunities in the data store; a list of the opportunities in a specified stage, in addition to, having a proposal date that occurs in two weeks or less from the current date; a list of the opportunities in a specified stage having a proposal date that has passed; a list of the opportunities that have been created during the current month; a list of the opportunities that have been closed during the current month; a list of the opportunities having been changed during the current month; a list of the opportunities that have been created during the current fiscal year; a list of the opportunities that have been closed during the current fiscal year; a list of the opportunities that have been changed during the current fiscal year; a list of the opportunities that have been created during the past X days, where X is a configurable number; a list of the opportunities that have been closed during the past X days, where X is a configurable number, or a list of the opportunities that have been changed during the past X days, where X is a configurable number.

In addition to the statistics shown on the dashboard of the present embodiment, there may be illustrative charts, step 107, displayed for and/or configured by the user, also depicted in exemplary screen shot of FIG. 4. These charts may graphically display the filtered list of opportunities broken down by certain opportunity attributes. Opportunity attributes may comprise: the length of time the opportunity has been open, or the number of opportunities that are in a certain stage of an opportunity lifecycle.

Charts can be configured, for example, as bar, line, pie charts, or dials. The chart's position and size, including whether the chart is displayed, can be configured during dashboard setup. The collection of charts shown may be further affected by the properties of an opportunity. In addition, charts can be dragged-and-dropped, step 108, as an image or other format, into other applications, such as, for example, Microsoft Word® or Microsoft PowerPoint®.

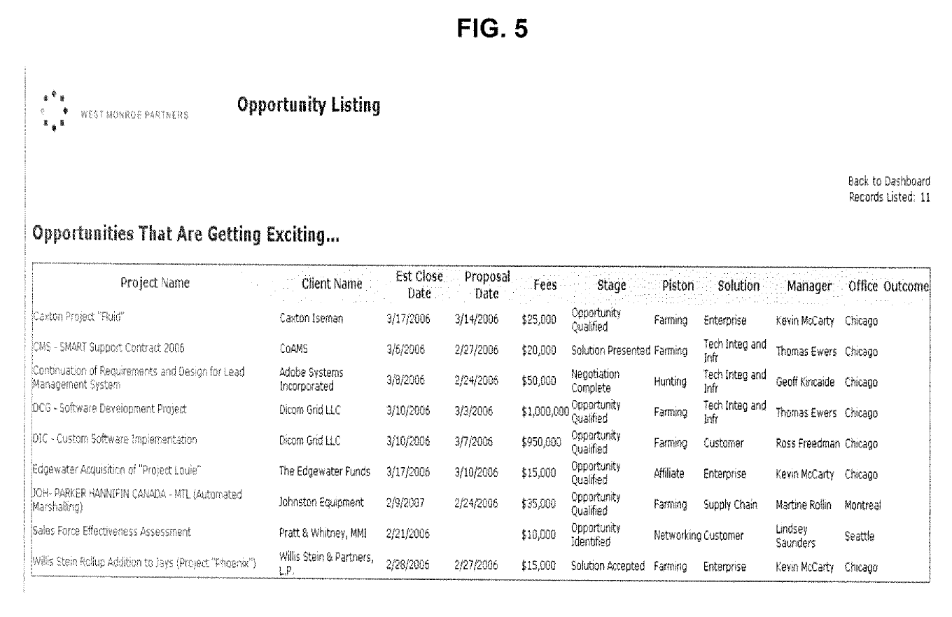

In one embodiment, charts may provide a graphical representation of the filtered opportunity list as well as mouse-over numerical data of the chart display. Further, the charts may provide the user with the ability to click through to a list screen, step 109, showing a table of filtered opportunities as well as the attributes about each opportunity. The user may migrate to this list screen by selecting one of the statistics shown on the dashboard. FIG. 5 is a screenshot of an exemplar embodiment for listing opportunities and associated data.

Further to one embodiment, as depicted in FIG. 1, the user may be provided a list screen, step 109, such that the user viewing the desired opportunities may sort the opportunities by one or more attributes. Additional opportunity data may further be viewed, such as individual opportunities, that might otherwise not be shown within the aggregated results displayed on the dashboard.

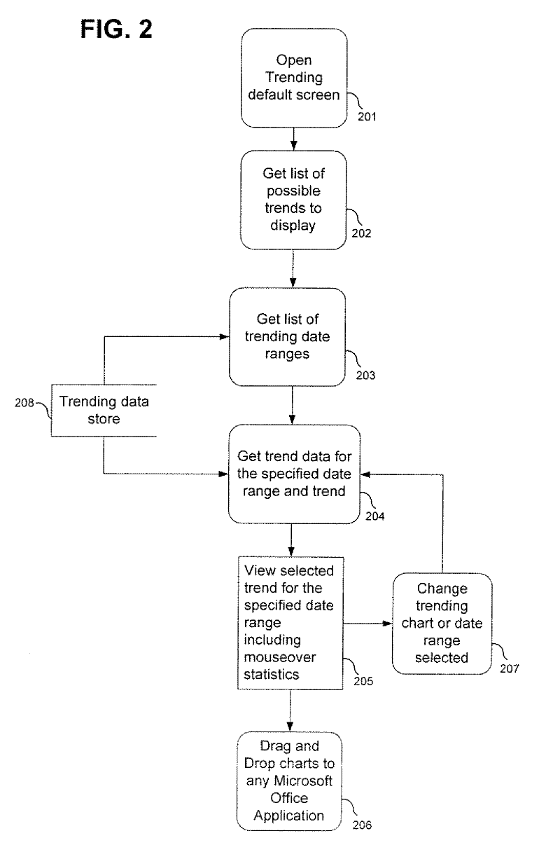

The trending portion of the dashboard may show opportunity, contact, and activity data over a specified time frame, such as for example, a weekly time frame. FIG. 2 depicts a flow diagram of illustrative steps for viewing the trending analysis. In this embodiment, opening a default trending screen 201 can provide the ability to acquire a list of possible trends to display 202 and dates ranges 203, from which the trending data store 208 can outline for selection. The trending data is gathered 204 based on the provided data and presented 205 for viewing and mouse-over statistics. The viewed trend data can be dragged and dropped 205 to another application or modified by changing the chart type or date range 207, causing the new data to be gathered and displayed.

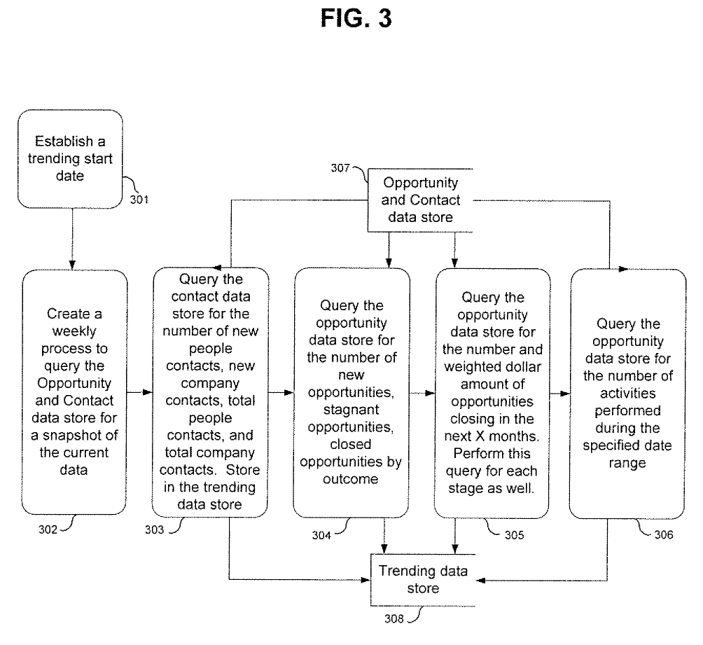

FIG. 3 depicts a flow diagram of illustrative steps for loading a trending data store, as depicted in FIG. 2, for possible use in performing trend analysis. In the illustrative example, the data for trending may be compiled from periodic snap-shots of the opportunity and contact data store 307. The data may be stored in a location, such as for example, a trending data store 308 after a start date 301 is established and the process created 302 to effectuate such a gathering of periodic data over some defined interval.

Predetermined intervals, such as for example, once a week, may be used to trigger collection of data associated with contacts 303, opportunities 304, predicted dollar values 305, and activities 306 for storage and use in performing trending analysis. Illustrative statistics that may be stored for each periodic collection may comprise: number of new people contacts (the number of people contacts entered into 307 during the specified week); number of new company contacts (the number of company contacts entered into 307 during the specified week); total number of people contacts (the total number of people contacts in the system as of the week end date); total number of company contacts (the total number of company contacts in the system as of the week end date); new opportunities (the number of new opportunities that were entered into the system during the specified week); stagnant opportunities (the number of open opportunities in the system that have not changed in N days as of the week end date, where n is a configurable number); closed opportunities by outcome (the number of opportunities that closed during the week range that were “won”, “lost”, or “neither”); the number of opportunities that are estimated to close in the next W months (where W is a configurable number); the number of opportunities that are estimated to close in the next X months grouped by opportunity sales stage (where X is a configurable number); the weighted fees of opportunities (estimated fees of the opportunity multiplied by the probability percentage of the opportunity) that are estimated to close in the next Y months (where Y is a configurable number); and the weighted fees of opportunities that are estimated to close in the next Z months grouped by opportunity sales stage (where Z is a configurable number).

Further to a dashboard embodiment, as shown in the screen shot of FIG. 4, the user may be presented a business development dashboard screen 400 where the user may select what stage 405 to present, such as for example, those listed under the opportunities by stage chart heading 440, including, but not limited to, lead generated, opportunity identified, opportunity qualified, solution presented, solution accepted, and/or negotiation completed. A user may further select an office 410, and narrow the displayed data by providing a date range 415 and 420 prior to applying the fitter, as operatively employed by selecting an “apply filter” button 425. Graphical representation in the form of either a bar chart, such as that illustrated with “opportunity aging” 435, or with “opportunities by solution offering” 450; or a pie chart such as that illustrated with “opportunities by piston” 445, or with “opportunities by stage” 440 can be accompanied by the numerical and percentile data used to generate the charts, thereby providing the user with more detail regarding the activity of the opportunities. Certain data may be represented by other chart forms, such as that used in screen shot 400 to depict the conversion ratio 455 data. The conversion ratio, values representing opportunities having come to fruition, might be displayed by a radial dial indicating the number of opportunities converted. Representations may comprise the month-to-date (MTD), year-to-date (YTD) or all time figures.

In the embodiment illustrated by FIG. 4, and operatively configured by the aforementioned steps 405, 410, 415, 420 and 425, data related to specific activity criteria may be displayed in numerical form 430 which may comprise: total opportunities (open and active); total opportunities (open and on hold); overdue opportunities; proposals next two weeks; proposals overdue; new opportunities; opportunities closed; and opportunities changed. Further, some data, such as those mentioned herein, by example, may be parsed by last-N-days or month-to-date (MTD).

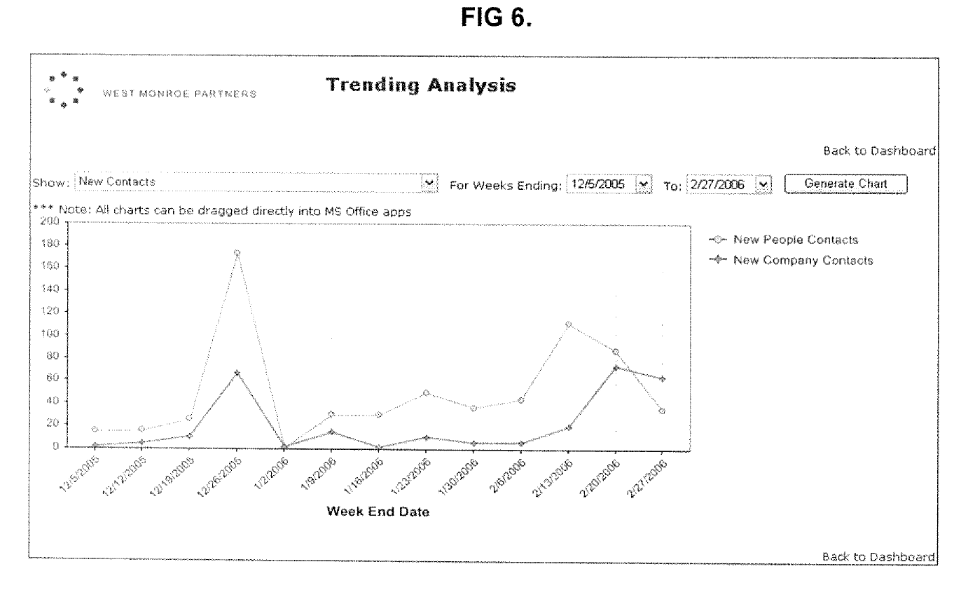

A user may desire to view more specific trending data. In an embodiment of the “dashboard” screen 400, a user may navigate to a graphical representation of trending analysis by operatively employing the “view trending” icon 460. Graphical interfaces, such as those embodied in screen shots of FIG. 6 through FIG. 12, may allow a user to configure the display of trending data.

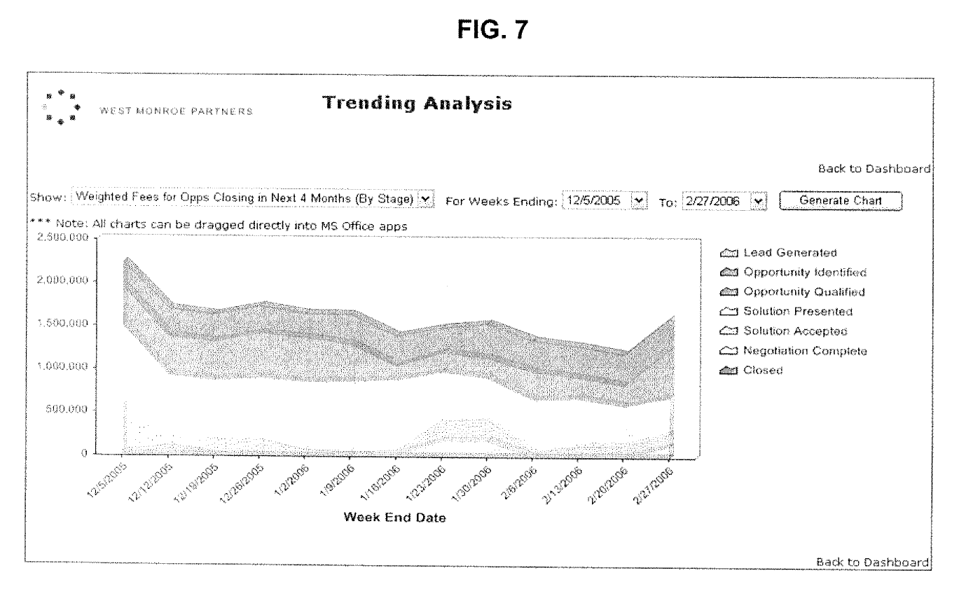

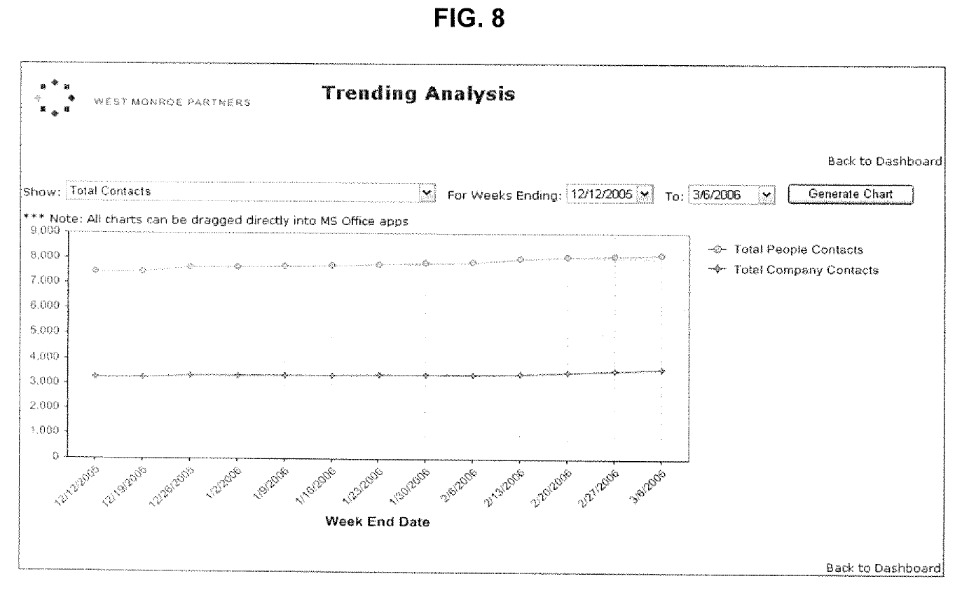

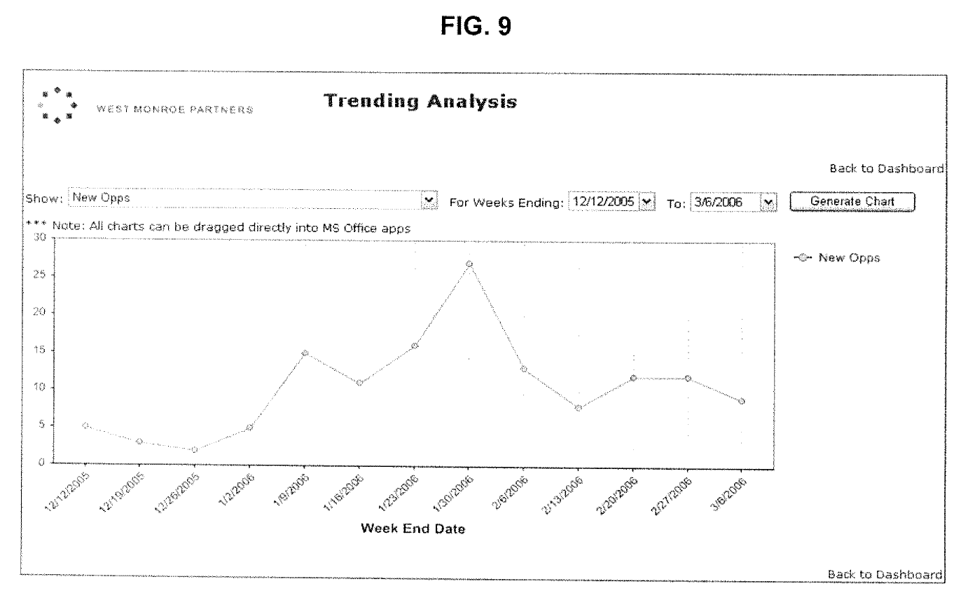

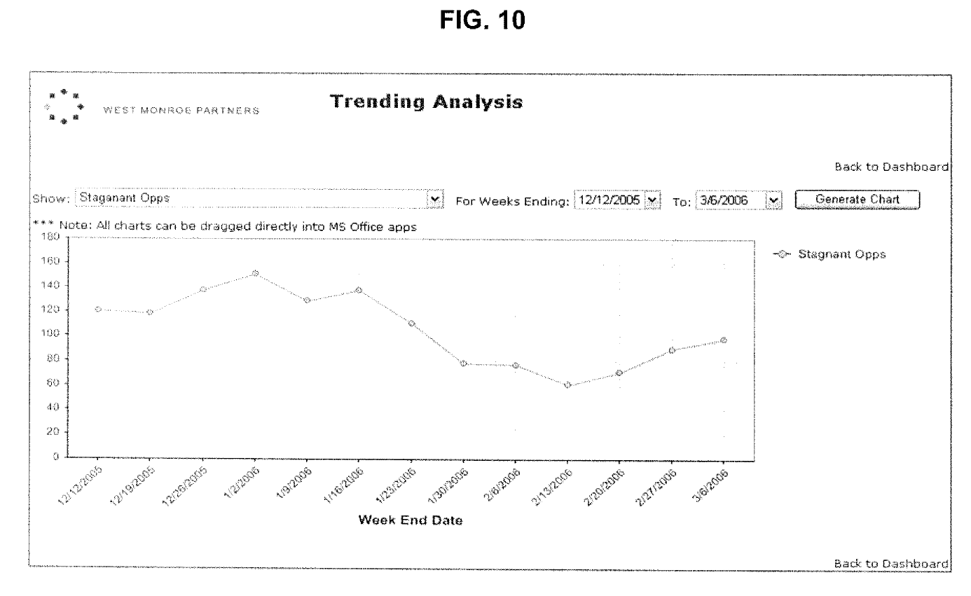

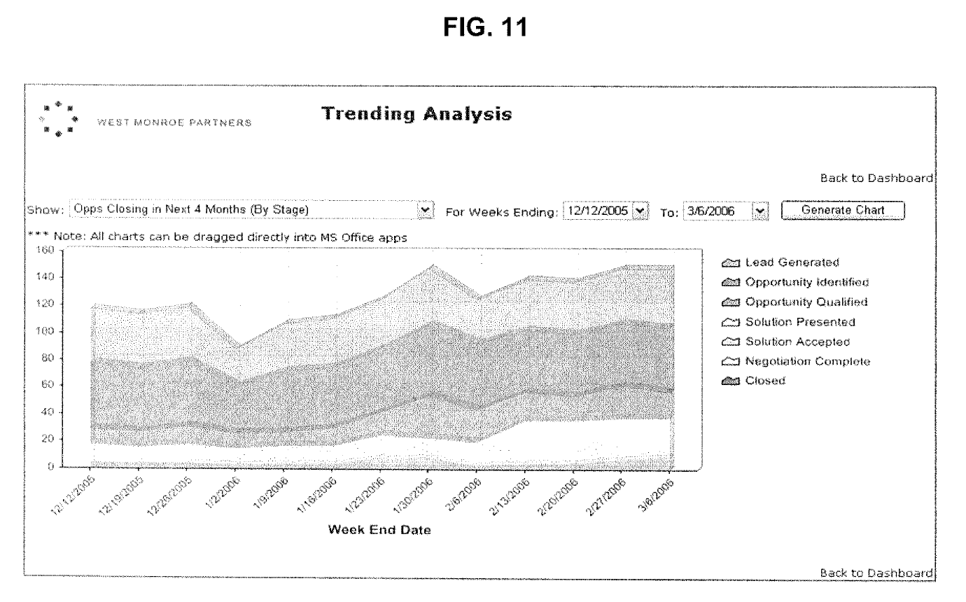

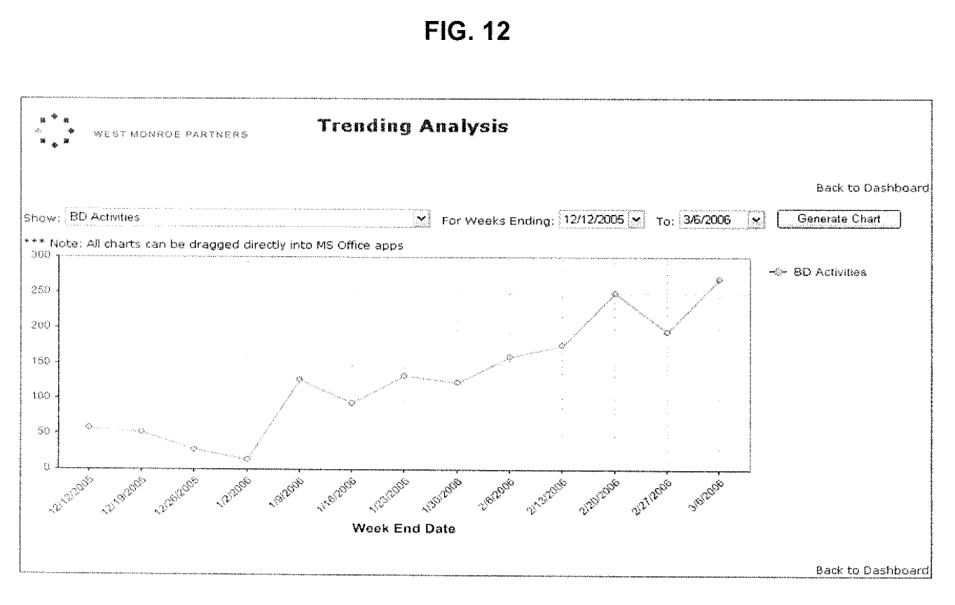

One embodiment of the trending analysis screen is shown in FIG. 6, where new contacts for weeks ending Dec. 5, 2005 to Feb. 27, 2006 are displayed in graphical format. Another embodiment of the trending analysis screen is shown in FIG. 7, where weighted fees for opportunities closing in the next four months by stage for the weeks ending Dec. 5, 2005 to Feb. 27, 2006 are displayed in graphical format. Another embodiment of the trending analysis screen is shown in FIG. 8, where total contacts for the weeks ending Dec. 2, 2005 to Mar. 6, 2006 are displayed in graphical format. Another embodiment of the trending analysis screen is shown in FIG. 9, where new opportunities for weeks ending Dec. 12, 2005 to Mar. 6, 2006 are displayed in graphical format. Another embodiment of the trending analysis screen is shown in FIG. 10, where stagnant opportunities for weeks ending Dec. 12, 2005 to Mar. 6, 2006 are displayed in graphical format. Another embodiment of the trending analysis screen is shown in FIG. 11, where opportunities closing in the next four months, by stage, for the weeks ending Dec. 12, 2005 to Mar. 6, 2006 are displayed in graphical format. Another embodiment of the trending analysis screen is shown in FIG. 12, where business development activities for the weeks ending 12/2005 to Mar. 6, 2006 are displayed in graphical format.

The dashboard may provide a user with the capability to configure the interface attributes. In one embodiment, one setting may control all the statistics. In another embodiment, the dashboard configuration capabilities may comprise: the dashboard titles, dashboard page headers, the logo; the fiscal year-to-date statistics and start-month and start-day; the last-N-months of desired opportunity statistics; the chart titles and size; the chart color palettes; the chart positions; the dial chart's red (low) value; the dial chart's green (high) value; the dial chart's minimum value; the dial chart's maximum value; the trending chart size; and the trending analysis default week values.

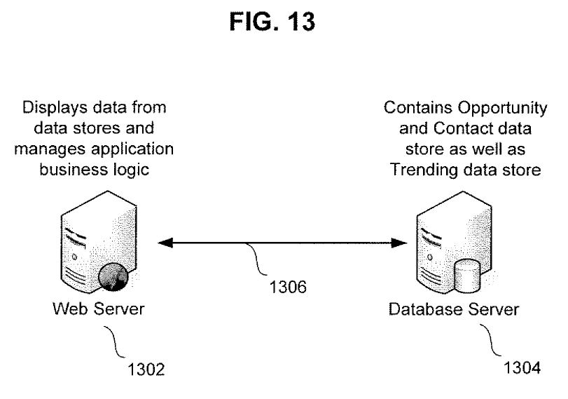

A data processing system to facilitate the methods described herein may include several servers, not necessarily configured on different hardware. In one embodiment, as depicted in the block diagram of FIG. 13, two servers, a web server 1302 and database server 1304, are operatively configured to communicate over a network 1306, such as for example, a local area network, a wide area network, or the Internet. The data processing system comprises web server 1302 operatively configured to display data from data stores and manage application business logic, and a database server 1304 configured to manage and store the opportunity, contact and trending data stores. In such an embodiment, a user may interact with the data stored on the database server via the web server. Access may be granted via a widely-disseminated publicly-accessible network, such as the World Wide Web (not shown), to which a user could request an appropriate page, such as for example, the dashboard. A different user, such as an administrator, may access the data in a similar manner, with the possible exception of providing a secure login to gain access to more features and attributes of the system. Alternatively a user, such as an administrator, may access the data stored on the database server directly, without going over, for example, the World Wide Web.

In yet another embodiment a user of the dashboard system may invoke requests to the web server desiring specific data, as that may be narrowed by selection of the aforementioned criteria, such as for example, “new contacts for the week of Dec. 12, 2005 to Feb. 27, 2006,” as depicted in FIG. 6. Such a request may be generated by a user and sent over the widely-disseminated publicly-accessible network, such as the World Wide Web, to the web server. Further to the present embodiment, the web server may compile the user's request to forward the criteria to the database server in the form of a query, such as for example, an SQL statement, so as to retrieve the user's desired data. The web server might then compile the necessary instructions to operatively provide the user with the requested data in the appropriate format.

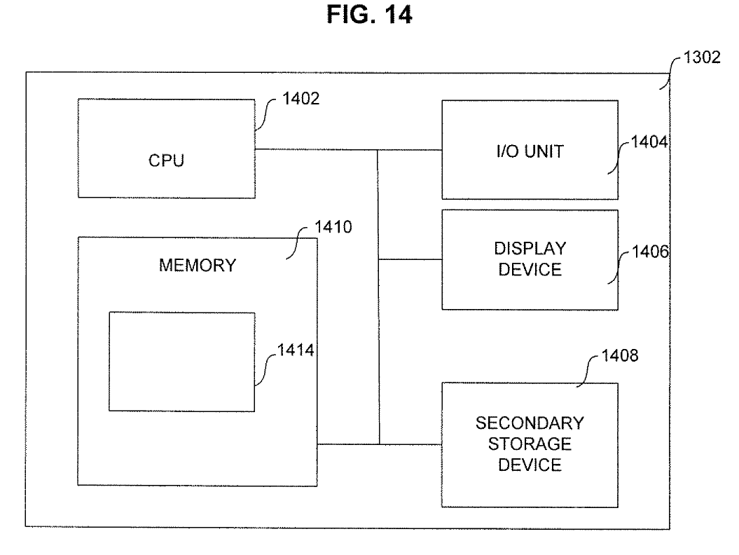

FIG. 14 is a view of one possible embodiment of a web server 1302. The illustrative web server comprises a central processing unit (CPU) 1402, an input/output (I/O) unit 1404, a display device 1406, a secondary storage device 1408, and a memory 1410. The web server may further comprise standard input devices such as a keyboard, a mouse or a speech processing means (each not illustrated). Memory 1410 may comprise one or more software components 1414, including the dashboard program.

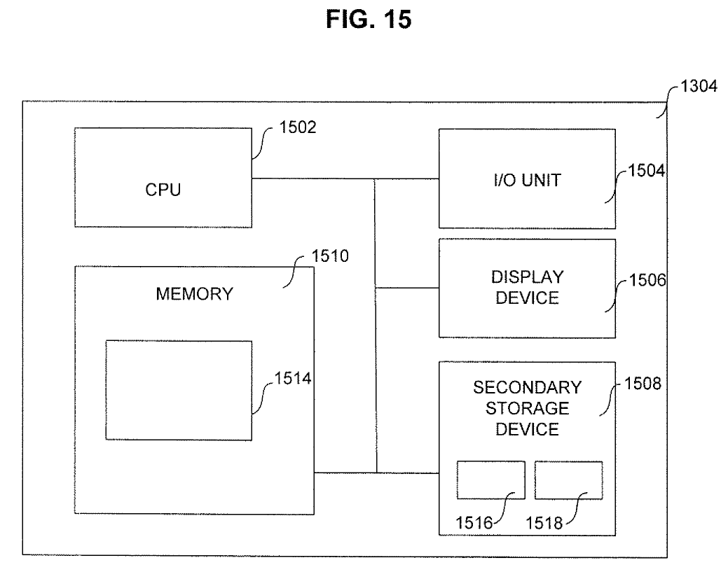

FIG. 15 is a view of database server 1304. The illustrative database server comprises central processing unit (CPU) 1502, an input/output (I/O) unit, display device 1506, secondary storage device 1508, and memory 1510. The database server may further comprise standard input devices such as a keyboard, a mouse or a speech processing means (each not illustrated). Memory 1510 may comprise one or more software components 1514, including a program for managing the opportunity and contact data store 1516 and the trending data store 1518.

One of skill in the alt will appreciate that each program and module described herein can be a stand-alone program and can reside in memory on a data processing system other than the described system. The program and modules may comprise or may be included in one or more code sections containing instructions for performing their respective operations. While the programs and modules are described as being implemented as software, the present implementation may be implemented as a combination of hardware and software or hardware alone. Also, one having skill in the art will appreciate that the programs and modules may comprise or may be included in a data processing device, which may be a client or a server, communicating with described system.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the system have been described, one skilled in the art will appreciate that a data processing system suitable for use with methods, systems, and articles of manufacture consistent with the present invention may contain additional or different components. For example, the programs and data stores described herein may reside on a single data processing system, such as web server 1302.

One having skill in the art will appreciate that the data processing systems can themselves also be implemented as client-server data processing systems. A program or module can be stored on, for example, the host system as a client, while some or all of the steps of the processing of the program or module can be carried out on a remote server, which is accessed by the system over the network. The remote server can comprise components similar to those described above with respect to the web server or database server, such as a CPU, an I/O, a memory, a secondary storage, and a display device.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software, but the present invention may be implemented as a combination of hardware and software or hardware alone. The invention may be implemented with both object-oriented and non-object-oriented programming systems. The scope of the invention is defined by the claims and their equivalents.

### STATEMENT REGARDING PREFERRED EMBODIMENTS

While the invention has been described with respect to the foregoing, those skilled in the are will readily appreciate that various changes and/or modifications can be made to the invention without departing from the spirit or scope of the invention as defined by the appended claims.

What is claimed is:

1. A computer-implemented method comprising:
retrieving data pertaining to an attribute of a business opportunity; and
depicting said attribute in a graphical or chart representation.

2. The method of claim 1 wherein the retrieved data pertaining to an attribute of said business opportunity is filtered by filter criteria before depicting said attribute.

3. The method of claim 1 wherein said depicting of a graphical or chart representation is derived from information gleaned at a plurality of points in time.

4. The method of claim 1 further comprising the step of statistically analyzing the data represented by said graphical or chart representation to determine valid trend data.

5. A computer network system having a plurality of servers and a plurality of clients, said system further comprising:
means for querying a database comprising information pertaining to one or more opportunities and attributes associated with such opportunities; and
means for analyzing said information to determine the number of opportunities associated with one or more of such attributes that have been realized.

6. A computer-implemented method comprising:
setting filter parameters with respect to the attributes of an opportunity;
obtaining information pertaining to opportunities meeting the set filter parameters; and
depicting said filtered information in a graphical or chart representation.

7. A computer network system comprising:
means for querying a database comprising information pertaining to one or more opportunities and attributes associated with such opportunities;
means for depicting said opportunity attribute(s) in graphical or chart form; and
means for permitting said graphical or chart form into unrelated application software.

8. The computer network system of claim 7 wherein there is further provided means for generating trend data pertaining to one or more of said attribute(s) of said opportunity.
